(19) United States
(12) Patent Application Publication
(10) Pub. No.: US 2026/0031970 A1
(43) Pub. Date: Jan. 29, 2026

(54) SYSTEMS AND METHODS FOR SYNCHRONIZING WITH RADIO FREQUENCY SIGNALS

(71) Applicant: Skyworks Solutions, Inc., Irvine, CA (US)

(72) Inventors: Connor William Blasie, Austin, TX (US); Alexander Kleinerman, Austin, TX (US)

(21) Appl. No.: 19/279,950

(22) Filed: Jul. 24, 2025

Related U.S. Application Data
(60) Provisional application No. 63/675,898, filed on Jul. 26, 2024.
(60) Provisional application No. 63/675,911, filed on Jul. 26, 2024.

(51) Int. Cl. H04L 7/04; H04L 7/00

(52) U.S. Cl. CPC H04L 7/041; H04L 7/0004; H04L 7/0066; H04L 7/0079

(57) ABSTRACT

Systems and methods for synchronizing with and decoding radio frequency signals are provided. In one aspect, a radio receiver includes an antenna configured to receive a radio frequency signal and digital signal processing circuitry configured to receive the radio frequency signal from the antenna and perform a first synchronization algorithm and a second synchronization algorithm on the radio frequency signal in parallel. The digital signal processing circuitry is further configured to determine which of the first synchronization algorithm and the second synchronization algorithm completes first and begin playback on the radio frequency signal based on synchronization with the radio frequency signal based on the determination of which of the first synchronization algorithm and the second synchronization algorithm completed first.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

Embodiments of this disclosure relate to techniques for processing radio frequency signals, and in particular, synchronizing with and decoding radio frequency signals.

### Description of the Related Technology

Radio receivers are omnipresent in modern technology. In addition to standalone radios for receipt of broadcast radio signals, all manners of tech and non-tech devices include some type of radio receiver (and often paired with a transmitter). Such modem circuitry is present in any device having wireless capabilities. While some broadcast radio signals are transmitted with analog coding (e.g., conventional AM and FM signals), other terrestrial and satellite wireless communication systems use some type of digital encoding. Some example digital radio systems include National Radio System Committee (NRSC-5C, also known as HD™ radio), Digital Audio Broadcasting (DAB), Digital Radio Mondiale (DRM) or other standard.

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

One aspect of this disclosure is a radio receiver comprising: digital signal processing circuitry configured to receive a radio frequency signal from an antenna, perform a first synchronization algorithm and a second synchronization algorithm on the radio frequency signal in parallel, determine which of the first synchronization algorithm and the second synchronization algorithm completes first, and begin playback on the radio frequency signal based on synchronization with the radio frequency signal based on the determination of which of the first synchronization algorithm and the second synchronization algorithm completed first.

In some embodiments, the first synchronization algorithm is processed on a longer duration than the second synchronization algorithm.

In some embodiments, the second synchronization algorithm is processed on a duration of about a single symbol and the first synchronization algorithm is processed on a duration based on about a length of a frame.

In some embodiments, the second synchronization algorithm is processed on a duration of about a single symbol and the first synchronization algorithm is processed on a duration based on about a length of a super frame.

In some embodiments, the second synchronization algorithm is processed on a duration of about a length of a frame and the first synchronization algorithm is processed on a duration based on about a length of a super frame.

In some embodiments, the first synchronization algorithm includes: determining whether pilots are present in the radio frequency signal, and in response to determining that pilots are present in the radio frequency signal, determining if there is an interfering tone present in the radio frequency signal.

In some embodiments, the digital signal processing circuitry is further configured to: disable second synchronization algorithm in response to determining that the interfering tone is present in the radio frequency signal.

In some embodiments, the digital signal processing circuitry is further configured to, in response to determining that no interfering tone is present in the radio frequency signal: determine a robustness mode of the radio frequency signal, find one or more symbol boundaries of the radio frequency signal, determine whether a time reference cell is present in a current frame of symbols of the radio frequency signal, and find a symbol start location of the radio frequency signal.

In some embodiments, the digital signal processing circuitry is further configured to, in response to determining the robustness mode and finding the symbol start location of the radio frequency signal: estimate and removing a fractional frequency offset a boundary of a current symbol, and find whether a time reference cell is present in the current symbol.

In some embodiments, the second synchronization algorithm includes finding a robustness mode of the radio frequency signal and a symbol start location on a symbol basis.

In some embodiments, the second synchronization algorithm further includes, in response to finding the robustness mode of the radio frequency signal: continuing to find the symbol start location on the symbol basis, estimating and removing a fractional frequency offset on a boundary of a current symbol, and estimating a time reference cell and an integral frequency offset on the current symbol.

In some embodiments, the digital signal processing circuitry is further configured to: maintain a current state of each of the first synchronization algorithm and the second synchronization algorithm in a state machine, and update the current state of each of the first synchronization algorithm and the second synchronization algorithm based on the determination of which of the first synchronization algorithm and the second synchronization algorithm completes first.

Another aspect is a method of synchronizing with a radio frequency signal, comprising: receive the radio frequency signal from an antenna; performing a first synchronization algorithm and a second synchronization algorithm on the radio frequency signal in parallel, determining which of the first synchronization algorithm and the second synchronization algorithm completes first; and beginning playback on the radio frequency signal based on synchronization with the radio frequency signal based on the determination of which of the first synchronization algorithm and the second synchronization algorithm completed first.

In some embodiments, the first synchronization algorithm is processed on a longer duration than the second synchronization algorithm.

In some embodiments, the second synchronization algorithm is processed on a duration of about a single symbol and the first synchronization algorithm is processed on a duration based on about a length of a frame.

In some embodiments, the first synchronization algorithm includes: determining whether pilots are present in the radio frequency signal, and in response to determining that pilots are present in the radio frequency signal, determining if there is an interfering tone present in the radio frequency signal.

In some embodiments, the method further comprises: disabling second synchronization algorithm in response to determining that the interfering tone is present in the radio frequency signal.

In some embodiments, the method further comprises, in response to determining that no interfering tone is present in the radio frequency signal: determining a robustness mode of the radio frequency signal, finding one or more symbol boundaries of the radio frequency signal, determining whether a time reference cell is present in a current frame of symbols of the radio frequency signal, and finding a symbol start location of the radio frequency signal.

Yet another aspect is a wireless communication device comprising: an antenna; and transceiver circuitry in communication with the antenna and configured to receive a radio frequency signal from the antenna, perform a first synchronization algorithm and a second synchronization algorithm on the radio frequency signal in parallel, determine which of the first synchronization algorithm and the second synchronization algorithm completes first, and begin playback on the radio frequency signal based on synchronization with the radio frequency signal based on the determination of which of the first synchronization algorithm and the second synchronization algorithm completed first.

In some embodiments, the first synchronization algorithm is processed on a longer duration than the second synchronization algorithm.

Still yet another aspect is a radio receiver comprising: digital signal processing circuitry configured to receive an indication of which of a first synchronization algorithm and a second synchronization algorithm completed synchronization with a radio frequency signal first, demodulate and decode fast access channel data from the radio frequency signal, and begin playback of the radio frequency signal reusing the fast access channel data and based on the indication of which of the first synchronization algorithm and the second synchronization algorithm completed synchronization with the radio frequency signal first.

In some embodiments, the first synchronization algorithm is processed on a longer duration than the second synchronization algorithm.

In some embodiments, the second synchronization algorithm is processed on a duration of about a single symbol and the first synchronization algorithm is processed on a duration based on about a length of a frame.

In some embodiments, the digital signal processing circuitry is further configured to, in response to the received indication indicating that the second synchronization algorithm completed synchronization with the radio frequency signal first: determine whether to obtain a new time reference cell; and in response to determining to obtain the new time reference cell, perform demodulating and decoding of the fast access channel data from the radio frequency signal again.

In some embodiments, the digital signal processing circuitry is further configured to: performing one or more cyclic redundancy checks on the fast access channel data, and in response to determining that the fast access channel data has failed a predetermined number of cyclic redundancy checks, reinitialize the radio receiver and performing the first synchronization algorithm and the second synchronization algorithm on the radio frequency signal in parallel.

In some embodiments, the digital signal processing circuitry is further configured to, in response to received indication indicating that the second synchronization algorithm completed synchronization with the radio frequency signal first without demodulating and decoding an integral frequency offset of the radio frequency signal: demodulate and decode an integral frequency offset of the radio frequency signal after beginning playback of the radio frequency signal.

In some embodiments, the digital signal processing circuitry is further configured to: demodulate and decode a service description channel of the radio frequency signal using the fast access channel data after beginning playback of the radio frequency signal.

In some embodiments, the digital signal processing circuitry is further configured to: demodulate and decode a main service channel of the radio frequency signal using the service description channel.

Another aspect is a method of synchronizing with a radio frequency signal, comprising: receiving an indication of which of a first synchronization algorithm and a second synchronization algorithm completed synchronization with the radio frequency signal first; demodulating and decoding fast access channel data from the radio frequency signal, and beginning playback of the radio frequency signal reusing the fast access channel data and based on the indication of which of the first synchronization algorithm and the second synchronization algorithm completed synchronization with the radio frequency signal first.

In some embodiments, the first synchronization algorithm is processed on a longer duration than the second synchronization algorithm.

In some embodiments, the second synchronization algorithm is processed on a duration of about a single symbol and the first synchronization algorithm is processed on a duration based on about a length of a frame.

In some embodiments, the method further comprises, in response to the received indication indicating that the second synchronization algorithm completed synchronization with the radio frequency signal first: determining whether to obtain a new time reference cell; and in response to determining to obtain the new time reference cell, performing demodulating and decoding of the fast access channel data from the radio frequency signal again.

In some embodiments, the method further comprises: performing one or more cyclic redundancy checks on the fast access channel data, and in response to determining that the fast access channel data has failed a predetermined number of cyclic redundancy checks, reinitializing and performing the first synchronization algorithm and the second synchronization algorithm on the radio frequency signal in parallel.

In some embodiments, the method further comprises, in response to received indication indicating that the second synchronization algorithm completed synchronization with the radio frequency signal first without demodulating and decoding an integral frequency offset of the radio frequency signal: demodulating and decoding an integral frequency offset of the radio frequency signal after beginning playback of the radio frequency signal.

In some embodiments, the method further comprises: demodulating and decoding a service description channel of the radio frequency signal using the fast access channel data after beginning playback of the radio frequency signal.

In some embodiments, the method further comprises: demodulating and decoding a main service channel of the radio frequency signal using the service description channel.

Yet another aspect is a wireless communication device comprising: an antenna; and transceiver circuitry in communication with the antenna and configured to receive an indication of which of a first synchronization algorithm and a second synchronization algorithm completed synchronization with a radio frequency signal first, demodulate and decode fast access channel data from the radio frequency signal, and begin playback of the radio frequency signal reusing the fast access channel data and based on the indication of which of the first synchronization algorithm and the second synchronization algorithm completed synchronization with the radio frequency signal first.

In some embodiments, the first synchronization algorithm is processed on a longer duration than the second synchronization algorithm.

In some embodiments, the second synchronization algorithm is processed on a duration of about a single symbol and the first synchronization algorithm is processed on a duration based on about a length of a frame.

In some embodiments, the transceiver circuitry is further configured to, in response to the received indication indicating that the second synchronization algorithm completed synchronization with the radio frequency signal first: determine whether to obtain a new time reference cell; and in response to determining to obtain the new time reference cell, perform demodulating and decoding of the fast access channel data from the radio frequency signal again.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the disclosure. In the figures, each identical or nearly identical component that is illustrated in various figures is represented by a like numeral. For purposes of clarity, not every component may be labeled in every figure. In the figures:

FIG. 1 is a schematic diagram of an example radio system according to an embodiment.

FIG. 2 is a block diagram of a receiver in accordance with aspects of this disclosure.

FIG. 3 illustrates the data structure for OFDM-based radio signals in accordance with aspects of this disclosure.

FIG. 4 illustrates the super frame structure for the DRM30 standard in accordance with aspects of this disclosure.

FIG. 5 is a flow chart illustrating a technique for an example synchronization algorithm.

FIG. 6 is a flow chart illustrating a technique for employing the two synchronization algorithms in accordance with aspects of this disclosure.

FIG. 7 illustrates a template for the state of the synchronization state machine used in the flowcharts illustrated in FIGS. 8 and 9 in accordance with aspects of this disclosure.

FIG. 8 illustrates an example flowchart for a method of synchronizing a radio receiver to a received RF signal in accordance with aspects of this disclosure.

FIG. 9 illustrates an example flowchart for a method of demodulating and decoding a received RF signal in accordance with aspects of this disclosure.

FIG. 10 is a schematic diagram illustrating the time to audio (TTA) for decoding an RF signal for three different cases in accordance with aspects of this disclosure.

FIG. 11 illustrates an example flowchart for a method of synchronizing a radio receiver to a received RF signal and demodulating/decoding the RF signal in accordance with aspects of this disclosure.

FIG. 12 shows a block diagram of a representative device which may be a given wireless device.

### DETAILED DESCRIPTION

For various different radio solutions that are configured to receive broadcast radio signals, it is desirable to reduce the amount of time between initially receiving a radio signal and beginning playback of the received radio signal to minimize the wait time experience by the user. However, it is also desirable to provide robust synchronization so that the radio signal can be reliably detected and decoded even in poor channel conditions, for example, having one or more interferes. Aspects of this disclosure relate to techniques for providing fast and robust detection of radio signals by using two synchronization routines jointly.

Aspects of this disclosure can be applied to different radio frequency communication standards, such as OFDM radio standards. Certain examples are provided with reference to the DRM30 radio standard, however, aspects of this disclosure can be applied to any OFDM radio standard and potentially other communication standards as well.

OFDM systems can be highly sensitive to impairing and/or interfering conditions, particularly when there are more than one impairing and/or interfering conditions. Radio signals often exist in already highly utilized spectrum so there may be both analog and digital broadcasts in and out of band of the desired signal. Jamming signals are often present and can take the form of spurious tonal impairments which can be caused by AM carrier frequencies, electric motors, switching circuits, etc. In automotive based radios, a moving radio receiver can also be impacted by doppler fades/shifts which further complicate radio signal reception. Further impairments may be present from timing and frequency imbalance in clocking crystal mismatch between the transmitter, receiver, and/or analog front-end mixers. In some cases, radio receiver design topologies may be designed specifically for various transmissions frequency bands (for example, LF, HF, VHF, UHF, etc.), for example, to address propagation wave duration.

One metric for measuring the amount of time between initially receiving a radio signal and beginning playback of the received radio signal is time to audio (TTA). As used herein, TTA generally refers to a measurement of the time from when an RF signal is received at the front end of the receiver antenna to when there is audio at the output of the receiving radio device. It is often desirable to deliver the fastest possible TTA while also maintaining high radio fidelity. In some embodiments, the amount of time it takes for the tuner to mix the RF signal to baseband may be negligible overhead relative to the baseband processing time.

Accordingly, aspects of this disclosure relate to providing radio receives that can reduce or minimize the average time to audio to the end user while also being robust enough to synchronize in various different impairing conditions.

### Introduction to Radio Systems

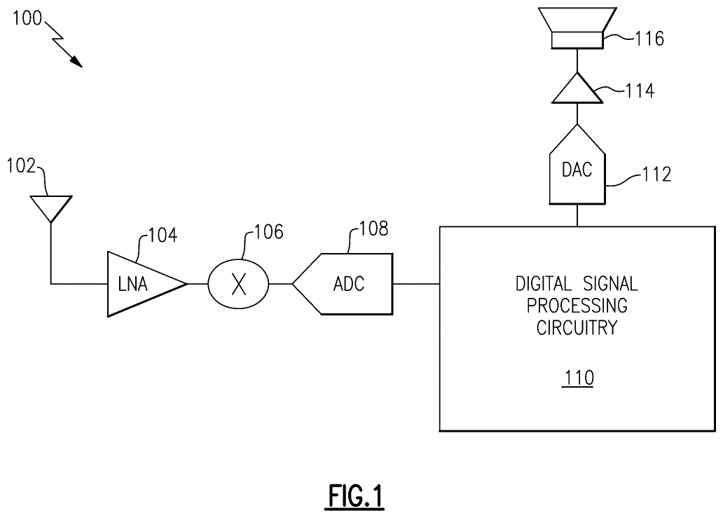

FIG. 1 is a schematic diagram of an example radio system 100 according to an embodiment. The radio system 100 can receive and process a digital radio signal. The radio system 100 can generate audio from the digital radio signal. The radio system 100 can process a digital radio signal that is in accordance one or more suitable digital radio standards, such as one or more of National Radio System Committee (NRSC-5C, also known as HD™ radio), DAB, Digital Radio Mondiale (DRM), Convergent Digital Radio (CDR), or another digital radio standard. As illustrated, the radio system 100 includes an antenna 102, a low noise amplifier 104, an analog-to-digital converter (ADC) 108, digital signal processing circuitry 110, a digital-to-analog converter (DAC) 112, an amplifier 114, and a speaker 116.

The radio system 100 is an example system that can process a received digital radio signal in accordance with any suitable principles and advantages disclosed herein. The digital signal processing circuitry 110 can estimate noise variance of the received digital radio signal in accordance with any suitable principles and advantages disclosed herein. The radio system 100 can be configured for receiving and processing the OFDM radio signals.

With reference to the radio system 100 of FIG. 1, a radio frequency signal that includes digital radio signals according to a given digital broadcast specification can be received via the antenna 102. In some instances, the radio frequency signal can be received via two or more antennas.

A radio frequency signal received via the antenna 102 can be processed by a receive signal path and provided to the digital signal processing circuitry 110. The radio frequency signal path includes at least a low noise amplifier (LNA) 104, a mixer 106, and an analog-to-digital converter 108. In some instances, the radio frequency signal path can include additional circuit elements, such as one or more filters, one or more amplifiers with automatic gain control, etc. A radio frequency signal received via 102 can be amplified by the LNA 104. The amplified RF signal can be downconverted by the mixer 106. The downconverted signal generated by the mixer 106 can be a low-intermediate frequency (IF) signal or a zero-IF signal, for example. The downconverted signal can include an in-phase/quadrature phase (IQ) signal. The ADC 108 can digitize the downconverted signal into a digital signal.

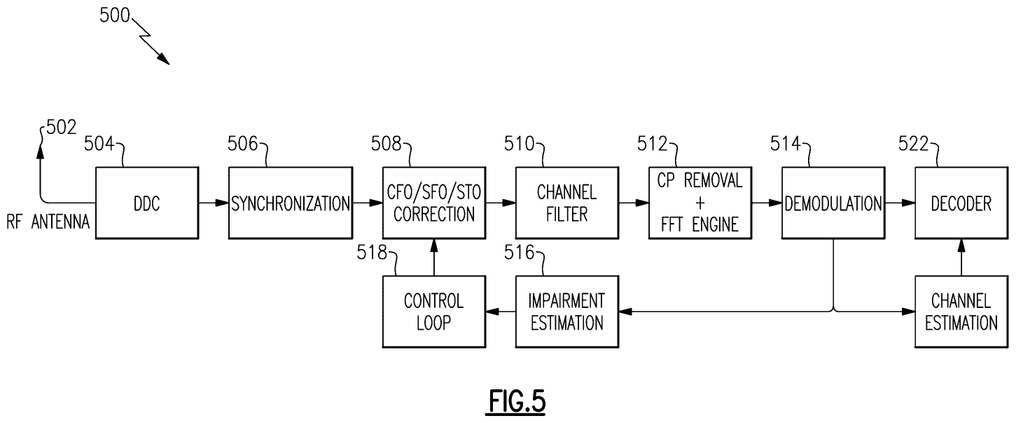

The digital signal processing circuitry 110 can perform any suitable processing on the digitized signal provided by the ADC 108. For example, the digital signal processing circuitry 110 can synchronize with a received RF signal and demodulate and decode the RF signal as described in connection with FIGS. 5-11. The digital signal processing circuitry 110 can playback the decoded RF signal with a lower average TTA in accordance with any suitable principles and advantages disclosed herein. The digital signal processing circuitry 110 can generate an audio output signal.

The audio output signal can be converted from a digital signal to an analog signal by a digital-to-analog converted (DAC) 112. The analog audio signal can be amplified by amplifier 114. The amplified analog audio signal can be provided to a speaker 116. The speaker 116 can output audio. While one speaker is shown in FIG. 1, audio can be output from any suitable number of speakers based on one or more audio signals provided by the digital signal processing circuitry 110.

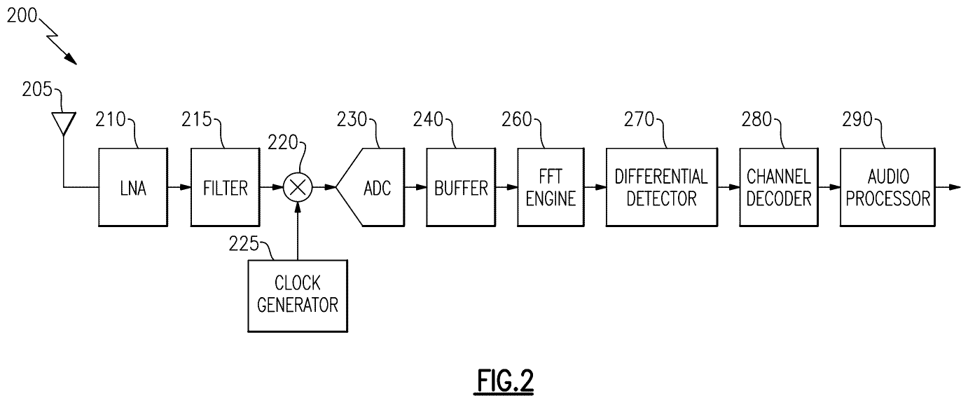

Referring now to FIG. 2, shown is a block diagram of a receiver in accordance with aspects of this disclosure. As shown in FIG. 2, receiver 200 may include a signal processing path having various components. Embodiments can be incorporated in different types of receiver systems. In some embodiments, receiver 200 may be a single-die integrated circuit such as a complementary metal-oxide-semiconductor (CMOS) die having mixed signal circuitry including both analog and digital circuitry.

With reference to receiver 200, an incoming RF signal that includes digital radio signals according to a given digital broadcast specification may be received over the air via an antenna 205. As used herein, the terms “digital radio” or “digital radio broadcast signal” are used interchangeably and are intended to correspond to broadcast radio communication that occurs digitally. Such communications may be in accordance with various standards such as a DAB or other standard.

As shown in FIG. 2, an incoming RF signal received via antenna 205 is provided to a low noise amplifier (LNA) 210, which amplifies the RF signal. In turn, LNA 210 is coupled to a filter 215, which may perform filtering of the received RF signal. In the embodiment of FIG. 2, the receiver 200 can include an RF front end that includes the LNA 210 and the filter 215. It will be understood that while shown with two RF front end blocks, a receiver 200 may include additional RF front end circuitry in other examples. In turn, the filtered RF signal is provided to a mixer 220, which in an embodiment may be implemented as a complex mixer. In embodiments herein mixer 220 may downconvert the RF signal to a lower frequency signal using a mixing signal received from a clock generator 225. In an embodiment, clock generator 225 may be implemented as a local oscillator, phase lock loop, or any other such clock generation circuit. In a particular embodiment, this lower frequency signal may be, e.g., a low-intermediate frequency (IF) or zero-IF signal. This downconverted signal may be an in-phase/quadrature phase (IQ) signal.

The resulting downconverted signal is provided to an analog-to-digital converter (ADC) 230, where the signal can be digitized into a digital signal. Note that in some embodiments, either before or after digitization, channelization may be performed to generate a channelized signal. In an OFDM system, a plurality of samples forms an OFDM symbol of an incoming data stream. Thus, the ADC can convert the received analog signal into digital symbols that can be processed by the components downstream from the ADC 230.

In turn, samples are provided to a buffer 240, which may be implemented as a first in first out (FIFO) buffer. The incoming samples are stored in buffer 240, and are then output to a main digital signal processing path including a fast Fourier transform (FFT) engine 260, which generates frequency domain OFDM symbols from incoming time domain OFDM symbols. In one embodiment, each incoming time domain OFDM symbol can be processed by FFT engine 260 into a plurality of frequency carriers. Note that the number of frequency carriers corresponding to a given OFDM symbol may vary depending upon a particular radio standard, bandwidth of the signal, and/or time duration of the OFDM symbol (without cyclic prefix (CP)).

As further shown in FIG. 2, frequency carriers generated in FFT engine 260 are provided to a differential detector 270 (also referred to as a “detector”). In embodiments herein, differential detector 270 may be a dedicated hardware circuit or a microcontroller or other control logic to execute instructions stored in a non-transitory storage medium such as firmware and/or software instructions. The differential detector 270 can include a coherent differential equalizer configured to perform channel estimations and use the channel estimate information to generate soft decisions, e.g., in the form of log likelihood ratio (LLR) values, as described herein. Of course, the differential detector 270 could be implemented in different ways in other embodiments.

In embodiments herein, differential detector 270 may generate LLR values for each pair of frequency carriers of the OFDM symbol. In turn, these LLR values may be provided to a channel decoder 280. In an embodiment, channel decoder 280 may be implemented as a Viterbi decoder to decode encoded message information based at least in part on the LLR values. Channel decoder also may be used to perform error correction and information bit extraction. The resulting demodulated signal may be provided to an audio processor 290 for audio processing. The encoded audio signal is then provided to an audio source decoder (not shown for case of illustration in FIG. 2) to generate source audio. Although shown as individual components, understand that portions of the receiver after ADC 230 to the end of the signal processing path of FIG. 2 can be implemented in a digital signal processor (DSP).

### Techniques for Reducing Time to Talk for Radio Receiver Synchronization

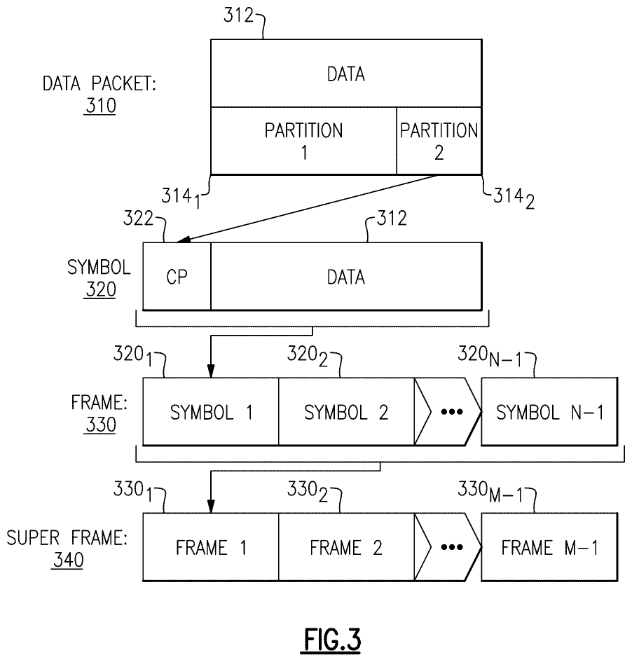

FIG. 3 illustrates the data structure for OFDM-based radio signals in accordance with aspects of this disclosure. As shown in FIG. 3, a data packet 310 can include data (also referred to as orthogonal data section) 312 which may be split into a first partition 314₁ and a second partition 314₂. The data packet 310 can be rearranged to form a symbol 320, including a cyclic prefix 322 and the data 312. In some embodiments, the cyclic prefix 322 can be constructed from the second partition 314₂ while the first and second partitions together 314₁ and 314₂ can form the data of the symbol 320.

With continued reference to FIG. 3, an OFDM frame 330 can be constructed from a plurality of symbols 320₁, 320₂, . . . , 320_{N-1}. In some cases, a plurality of frames 330₁, 330₂, . . . , 330_{M-1} can be combined to form a super frame 340.

### Example Applications for the DRM30 Standard

While aspects of this disclosure are applicable to various different RF standards, one particular standard for which aspects of this disclosure can be applied is the DRM30 standard. The DRM30 standard specifically has multiple interfering conditions to handle. Interfering AM carrier frequencies may present themselves as tones which can appear within band for the DRM30 receiver in which case tones can corrupt both cyclic-prefix correlations and the OFDM carriers. The DRM30 standard also has the potential for interfering digital broadcasts to be near the band of the desired broadcast which can limit the ability to detect and sync to the desired radio station.

The CFO is another impairment which can arise from the difference between the transmitter and receiver carrier frequencies, which can result in shifting the OFDM signal in the frequency spectrum. As used herein, CFO generally refers to the summation the integral frequency offset (IFO) and the fractional frequency offset (FFO). The IFO generally refers to an integer multiple offset of the carrier spacing and the FFO generally refers to a fraction of the carrier spacing.

Lastly, DRM30 exists in relatively lower frequency bands (e.g., <=30 MHz) which are more sensitive to frequency selective channels making synchronization more sensitive in such channels if not taken over enough OFDM symbols or frames. Radio receivers 200 are designed to robustly synchronize in the presence of one or more of the above-described interferers, which can result in more signal statics being collected, thereby delaying the start of the actual demodulation and decoding process of the transmitted data. These delays result in increasing the average TTA.

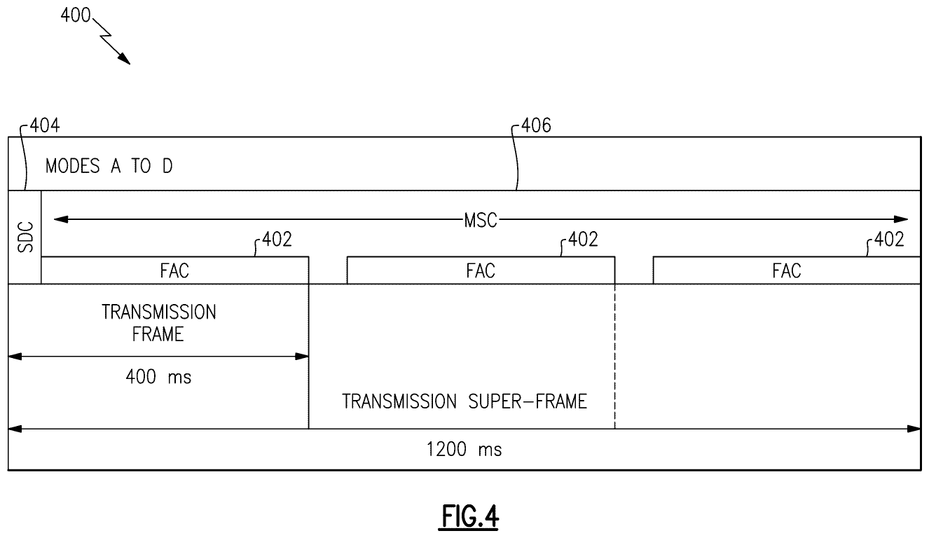

FIG. 4 illustrates the super frame structure for the DRM30 standard in accordance with aspects of this disclosure. In the DRM30 standard, an OFDM frame boundary is 400 msec with three frames constituting a super frame totaling 1200 msec. In DRM30, the super frame 400 includes three channels, a fast access channel (FAC) 402, a service description channel (SDC) 404, and a main service channel (MSC) 406.

There are continually transmitted frequency reference cell (FRC) pilots every symbol and time reference cell (TRC) transmitted in the first symbol of every frame. Once the frame boundary is found via synchronization, the receiver 200 can start processing the received data channels. Due to the structuring of the data channels 402-406, the radio receiver 200 first decodes the FAC 402, which is then used to decode the SDC 404. The decoded SDC 404 is then used to decode the MSC 406.

As shown in FIG. 3 and in the time interleaving of the data channels in FIG. 1, the FAC 402 and the MSC 406 can be found in each frame. However, the SDC 404 may only be found in the first frame of the super frame 400. This means that the relative TTA to when the radio receiver 200 can start processing the MSC 406 of a received RF signal can depend on which frame of the super frame 400 the radio receiver 200 starts processing. This is in part because the MSC 406 contains the audio and data content of the RF signal.

### Example Synchronization Techniques

FIG. 5 is a flow chart illustrating a technique for an example synchronization algorithm. With reference to FIG. 5, the synchronization technique 500 involves receiving an RF signal via an RF antenna 502, which is then processed into symbols at a DDC block 504. The method 500 next involves running a synchronization algorithm 506. The results of the synchronization algorithm 506 are provided to a correction block 508 configured to correct carrier frequency offset (CFO), sampling frequency offset (SFO), and/or symbol timing offset (STO).

The synchronization method 500 further includes a channel filter 510, a CP removal and FFT engine 512, and a demodulator 514. The demodulator 514 is configured to receive the output from the CP removal and FFT engine 512. The synchronization method 500 also includes an impairment estimator 516 configured to receive an output from the demodulator 514 and a control loop 518 configured to receive an estimation of the impairment from the impairment estimator 516 and provide closed loop feedback to the correction block 508. The synchronization method 500 further includes a channel estimator 520 configured to receive the output from the demodulator 514 and perform channel estimation and a decoder 522 configured to receive the output from the demodulator 514 and a channel estimate from the channel estimator 520 and decode the output from the demodulator 522.

Depending on the embodiment, the synchronization algorithm 506 may be configured to run on a symbol duration or a longer duration based on an OFDM frame. In some embodiments, the synchronization algorithm 506 can involve initially determining whether a DRM30 signal is present in the received RF signal and subsequently attempting to synchronize to an OFDM frame boundary on an OFDM frame basis. After the synchronization algorithm 506 finds a frame boundary, the decoder 522 can decode the FAC channel, followed by the SDC channel, and finally the MSC channel.

One drawback to using the synchronization algorithm 506 of FIG. 5 is that the time to audio can depend on which frame of the super frame is initially decoded due to the structure of the interleaved data channel in the frame. Another drawback relates to synchronization running on a robust frame basis. For example, running the synchronization algorithm 506 on a frame basis provides a robust synchronization process at the start of reception but this robustness comes at the cost of a constant delay in TTA regardless of channel conditions or presence of interfering signals.

### Synchronization With Multiple Synchronization Algorithms in Parallel

OFDM based radio receivers can be configured to process incoming RF radio signals based in part on two different durations, a “fast” duration and a “robust” duration. With reference back to FIG. 3, the fast duration may refer to the duration of a single OFDM symbol 320. For example, the fast duration may be the smallest organized time basis used including the data 312 and cyclic prefix 322. In some embodiments, such as when the cyclic prefix 322 is unavailable, the smallest organized time bases includes the data 312 and a zero-padded prefix. In other embodiments, the fast duration may refer to the duration of an OFDM sub-frame or an OFDM frame 330.

In some embodiments, the robust duration may refer to a plurality of fast duration elements. For example, the robust duration may include an OFDM sub-frame, an OFDM frame 330, an OFDM super-frame 340, etc.

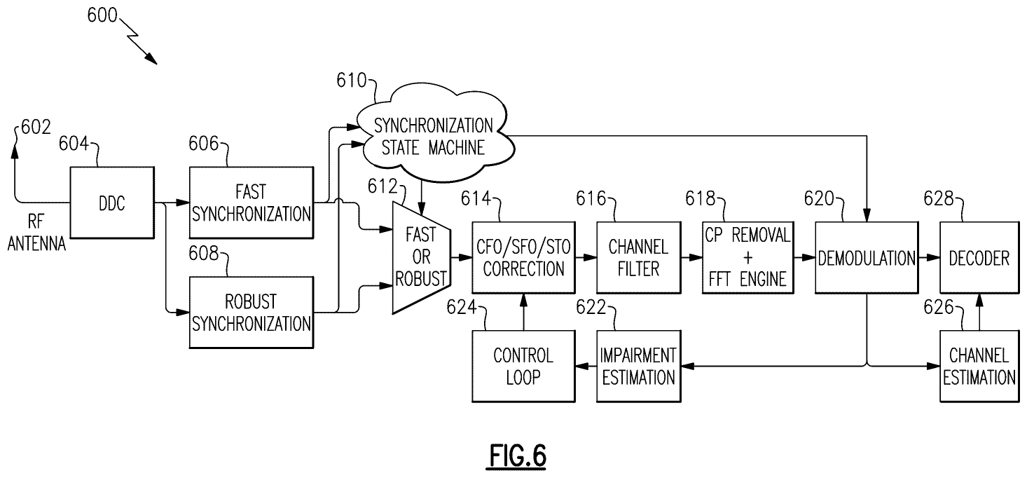

Aspects of this disclosure relate to a radio receiver that can implement at least two synchronization algorithms to synchronize with received RF signals. FIG. 6 is a flow chart illustrating a technique for employing the two synchronization algorithms in accordance with aspects of this disclosure.

With reference to FIG. 6, the synchronization method 600 involves receiving an RF signal via an RF antenna 602, which is then converted into a baseband signal in the digital domain at a digital down converter (DDC) 604. This conversion performed by the DDC 604 may be similar to processing performed by the LNA 210, filter 215, mixer 220, clock generator 225, and ADC 230 of the radio receiver 200 of FIG. 2. The method 600 next involves running both a fast synchronization algorithm 606 and a robust synchronization algorithm 608 in parallel. The results of both the fast synchronization algorithm 606 and the robust synchronization algorithm 608 are provided to a synchronization state machine 610 and a fast or robust synchronization decision block 612. The fast or robust synchronization decision block 612 outputs the results of the selected one of the fast synchronization algorithm 606 and the robust synchronization algorithm 608 to a correction block 614 configured to correct CFO, SFO, and/or STO.

The synchronization method 600 further includes a channel filter 616, a CP removal and FFT engine 618, and a demodulator 620. The demodulator 620 is configured to receive an output from the synchronization state machine 610 as well as the output from the CP removal and FFT engine 618. The synchronization method 600 also includes an impairment estimator 622 configured to receive an output from the demodulator 620 and a control loop 624 configured to receive an estimation of the impairment from the impairment estimator 622 and provide closed loop feedback to the correction block 614. The synchronization method 600 further includes a channel estimator 626 configured to receive the output from the demodulator 620 and perform channel estimation and a decoder 628 configured to receive the output from the demodulator 620 and a channel estimate from the channel estimator 626 and decode the output from the demodulator 620.

In certain embodiments, the fast synchronization algorithm 606 is configured to run on the fast duration while the robust synchronization algorithm 608 is configured to run on the robust duration. Depending on the embodiment, the fast duration may be the duration of about a single symbol or a length of a frame and the robust duration may be the duration of about a length of a frame or a super frame. The fast and robust synchronization algorithms 606 and 608 are further configured to jointly execute (e.g., run in parallel).

As described herein, the robust synchronization algorithm 608 is configured to collect more signal statistics compared to the fast synchronization algorithm 606 and thus can be relatively more robust under interfering conditions with the tradeoff of taking more time than the fast synchronization algorithm 606. Similarly, the fast synchronization algorithm 606 is configured to gathers fewer signal statics but in the event there are no significant interferers and sufficiently clean signal conditions, the fast synchronization algorithm 606 can be completed much more quickly than the robust synchronization algorithm 608. By using both the fast and robust synchronization algorithms 606 and 608 running in parallel, the receiver 200 can provide a faster average TTA in clean signal conditions while also providing robust synchronization in the presence of interfering and/or low signal-to-noise ratio (SNR) signals.

### Example Synchronization State Machine

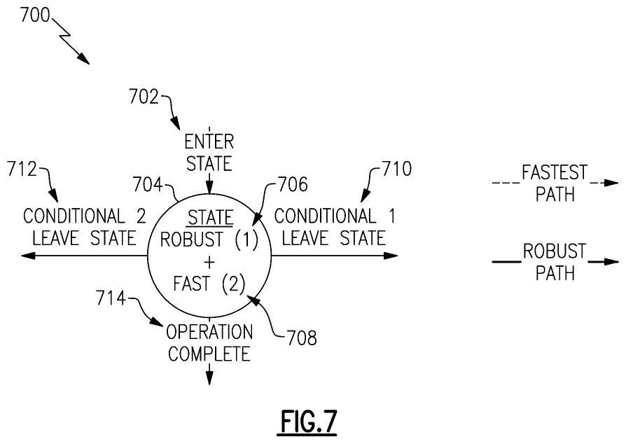

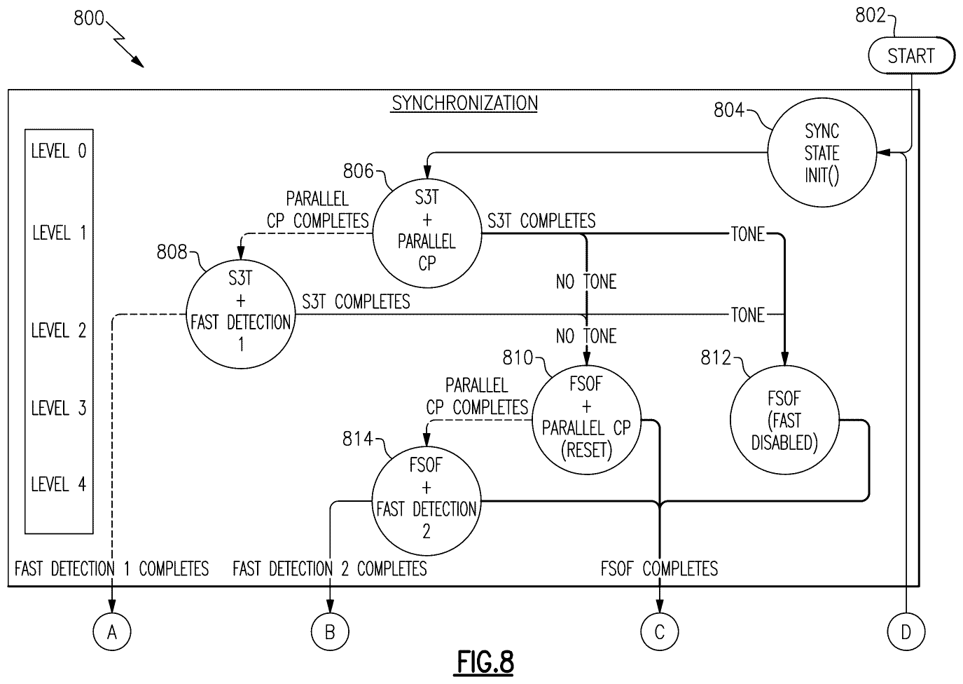

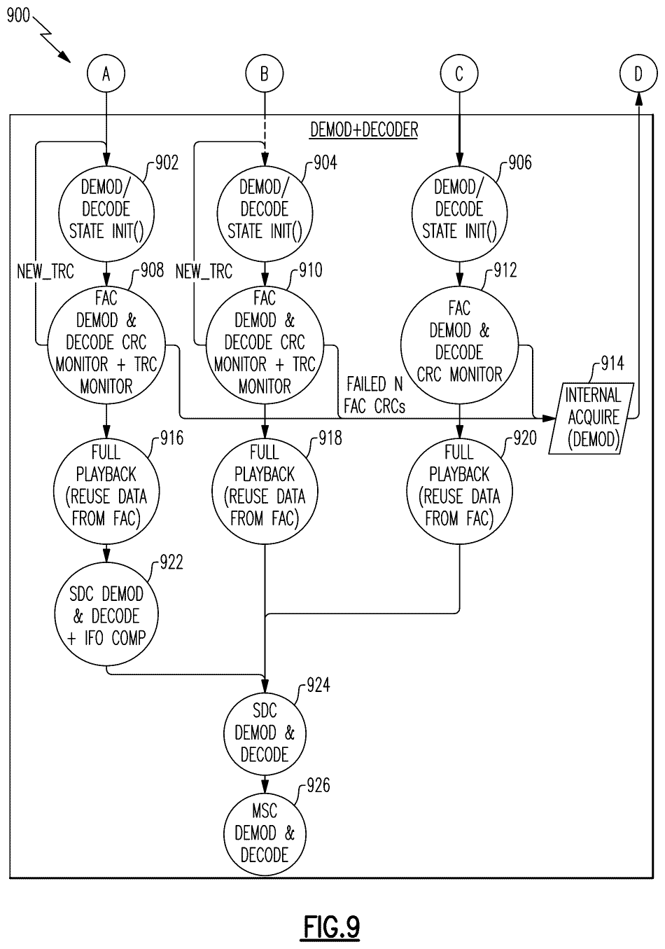

FIG. 7 illustrates a template 700 for the state of the synchronization state machine 610 used in the flowcharts 800, 900 illustrated in FIGS. 8 and 9 in accordance with aspects of this disclosure. As shown in FIG. 7, an enter state 702 is shown leading into the state 704 of the state machine (e.g., the synchronization state machine 610 illustrated in FIG. 6). The state 704 of the state machine includes the state 706 of the robust synchronization algorithm (e.g., the robust synchronization algorithm 608 illustrated in FIG. 6) as well as the state 708 of the fast synchronization algorithm (e.g., the fast synchronization algorithm 606 illustrated in FIG. 6). The state machine moves to a following step in the flowchart depending on whether the robust synchronization algorithm or the fast synchronization algorithm completed first. For example, when the robust synchronization algorithm completes first, the state machine follows conditional leave state 1 710 on the right of the state 704, and when the fast synchronization algorithm completes first, the state machine follows conditional leave state 2 712 on the left of the state 704. In the event that the state 704 of the state machine involves a processing operation, the state machine can follow an operation complete 714 path without exiting via the conditional leave states 710 or 712.

As described herein, aspects of this disclosure combine the solution of a slower “robust” synchronization process with a “fast” synchronization process that operates on a symbol basis. In many conditions, this design drastically speeds up the detection process of the signal on average to half a frame in clean signal conditions and as fast as a few OFDM symbols. For each state, the robust synchronization algorithm and the fast synchronization algorithm runs jointly depending on the progress of the state machine through the synchronization process.

Depending on the state 704 of the state machine, the robust synchronization algorithm can be implemented one of a plurality of robust algorithms. For example, the robust synchronization algorithms can include sync 3 tones (S3T) and find start of frame (FSOF), although other robust synchronism algorithms can be implemented in certain embodiments. In some embodiments, the S3T algorithm may be configured to sync to the FRC pilots. In some embodiments, the FSOF algorithm may be configured to find the start of the frame 320, as shown in FIG. 3. Similarly, the fast synchronization algorithm can be implemented by one or a plurality of fast algorithms depending on the state 704 of the state machine. For example, the fast synchronization algorithms can include parallel CP, fast detection 1, fast detection 2.

The S3T algorithm can be configured to detect FRC pilots in the received RF signal to determine if the DRM30 signal is present using power spectral density. If FRC are detected and present, the S3T algorithm can further be configured to determine and correct the CFO and determine if there are any interfering tones present which would destroy CP correlation.

The FSOF algorithm can be configured to determine if there is an interfering tone present, and if an interfering tone is detected, remove the interfering tone from the received RF signal on a frame basis. The FSOF algorithm can further be configured to detect the robustness mode of the RF signal based on CP correlation over a frame basis. The FSOF algorithm can also involve finding the symbol boundaries using CP correlation-energy minimization. CP correlation-energy minimization can include, for example, forming a histogram of symbol start locations over a frame basis. The FSOF algorithm can also find if the TRC is in the current frame of symbols which give the start of the frame.

The parallel CP algorithm can be configured to both find the robustness mode and the symbol start location using CP correlation-energy minimization on a symbol basis. The argument which minimizes the joint estimation can be determined to be the robustness mode with the position of the minimization being determined as the symbol boundary.

The fast detection 1 algorithm can be configured to continue to find the symbol start location using CP correlation-energy minimization on a symbol basis. The fast detection 1 algorithm is configured to operate on a symbol boundary continually updating the metric. The fast detection 1 algorithm can further estimate the FFO via CP correlation and remove the FFO on the current symbol boundary. The fast detection 1 algorithm can also involve jointly estimating the TRC and the IFO on the current symbol. The argument that minimizes the joint estimation can yield both the start of the frame and the CFO.

The fast detection 2 algorithm can be configured to continue to find the symbol start location with CP correlation-energy minimization on a symbol basis. The fast detection 2 algorithm can operate on a symbol boundary continually updating the metric. The fast detection 2 algorithm can further estimate the FFO via CP correlation and remove the FFO on the current symbol boundary. The fast detection 2 algorithm can also be configured to find if the TRC is in the current symbol which give the start of the frame.

### Example Synchronization State Algorithm

FIG. 8 illustrates an example flowchart for a method of synchronizing a radio receiver 200 to a received RF signal in accordance with aspects of this disclosure. The method 800 begins at block 802.

As shown on the left side of FIG. 8, block 804 occurs at level zero state of the state machine. In block 704, the radio receiver 200 initializes the radio receiver's 200 memory and clears all statuses. After initialization, the method 800 continues to block 806 at the level one state.

At block 806, the radio receiver 200 runs the S3T and parallel CP synchronization algorithms in parallel. For example, the robust synchronization algorithm 608 can run the S3T synchronization algorithm and the fast synchronization algorithm 606 can run the parallel CP synchronization algorithm. If the Parallel CP routine determines that there is a valid DRM signal present based on the joint CP Robustness mode estimation, then the method 800 moves to block 808 in the level two state.

If the S3T algorithm determines the DRM30 signal is present, it determines the CFO based on the FRC positions and also determines if there is an interfering tone. If there is an interfering tone, then the method 800 may refrain from running the fast detection process as this process can risk degradation in the process of a tone and thus moves to block 812 in level 3. If the S3T algorithm finds there is not an interfering tone, then the fast detection process will continue to run as the state is changed to block 810 of level 3. When exiting block 806 when the S3T algorithm completes, the CFO is corrected and a residual FFO may still be present in the received data set. However, when exiting block 806 when the parallel CP algorithm completes, the CFO may still be present in the received data set.

At block 808, the radio receiver 200 runs the S3T and fast detect 1 synchronization algorithms in parallel. If the fast detect 1 algorithm completes first, the method 800 moves onto the demodulation process as the start of the OFDM frame boundary was detected which continues at block 902 in the method 900 of FIG. 9. When the fast detect 1 algorithm completes first, the method 800 also updates the radio receiver 200 with the CFO estimate from the fast detection 1 process. If the S3T algorithm completes first, the method 800 proceeds to one of blocks 810 and 812 for the same reasons as discussed above in connection with block 806.

At block 810, the radio receiver 200 runs the robust synchronization algorithm (e.g., FSOF algorithm) and parallel CP synchronization algorithms in parallel. At block 810, the CFO has been corrected, so the parallel CP routine can run on CFO corrected data whereas the same routine running at block 808 in level two was running on non-CFO corrected data. If the parallel CP algorithm completes before the robust synchronization algorithm, the method 800 can move to block 814 of level four. However, if the robust synchronization algorithm completes first, the method 800 can move onto the demodulation process in block 906 of the method 900 of FIG. 9 as the start of the OFDM frame boundary was detected.

At block 812, the radio receiver 200 runs the robust synchronization algorithm with a known tone in the received data set. In some embodiments, block 812 can be run without a fast synchronization algorithm. Once the TRC is found, the method 800 moves onto the demodulation process at block 906 of the method 900 of FIG. 9 as the start of the OFDM frame boundary was detected. In both cases the CFO is already fully corrected and only a partial FFO may still be present in the received data set.

At block 814, the radio receiver 814 runs the robust synchronization algorithm (e.g., FSOF algorithm) and fast detect 2 synchronization algorithms in parallel. Either the of the robust synchronization algorithm and fast detect 2 algorithms can determine the TRC is present and then the method 800 moves onto the demodulation process at block 904 if the fast detect 2 algorithm completes first or at block 906 if the robust synchronization algorithm completes first as the start of the OFDM frame boundary was detected. In both cases the CFO is already fully corrected and only partial FFO may still be present in the received data set.

The synchronization techniques described herein increase the speed of synchronization by removing the constant TTA delay associated with a solely robust approach and enabling the radio receiver 200 to start the demodulation process earlier when the TRC is detected early via one of the two fast detection states. In certain circumstance, the fast synchronization algorithms may fail to complete in frequency selective channels and when there are interfering signals present. In these cases, the synchronization techniques can fall back on the robust synchronization algorithms. Embodiments of synchronization techniques described herein can maintain the ability to robustly synchronize to a received RF signal in the presence of large CFO, interfering signal, blocking signals, and/or frequency selective fading channels while also reducing the average TTA. For example, the average TTA may be reduced from multiple frames on average to as few as a few OFDM symbols in the fastest use cases with an on average fast detection of half an OFDM frame.

### Example Demodulation Techniques

FIG. 9 illustrates an example flowchart 900 for a method of demodulating and decoding a received RF signal in accordance with aspects of this disclosure. After completing synchronization according to the method 800 of FIG. 8, the radio receiver 200 can begin the method 900 of FIG. 9 for demodulating and decoding the RF signal. In the event that the fast detection 1 algorithm completed first, the method 900 proceed with block 902 in which the radio receiver 200 initializes the state of the synchronization state machine 610 for demodulating and decoding the RF signal. The method 900 involves the radio receiver 200 executing block 904 in response to the fast detection 2 algorithm completing first. Similarly, the method 900 involves the radio receiver 200 executing block 906 in response to the robust synchronization algorithm completing first. Blocks 904 and 906 may be substantially the same as block 902 in which the radio receiver 200 initializes the state of the synchronization state machine 610 for demodulating and decoding the RF signal.

In response to decoding the FAC data in one of blocks 902, 904, and 906, the method 900 proceeds to one of blocks 908, 910, and 912. Each of blocks 908, 910, and 912 involves the radio receiver 200 demodulating and decoding the FAC data. The radio receiver 200 may also run a cyclic redundancy check (CRC) monitor algorithm and a TRC monitor algorithm in blocks 908 and 910. In the event that the TRC monitor algorithm determines that a new TRC is required in either of block 908 or 910, the method may return from block 908 to block 902 or from block 910 to block 904. The radio receiver 200 may also run the CRC monitor algorithm in block 912. In response to a predetermined number of FAC failing the CRC checks in the CRC monitor algorithm in any of blocks 908, 910, and 912, the method 900 may proceed to block 914 at which the radio receiver 200 performs an internal acquire algorithm. From block 914, the method 900 returns to block 804 of method 800 to reinitialize the radio receiver's 200 memory and clear all statuses. For example, in the event that the predetermined number of FAC CRCs fail in the CRC monitor algorithm, it may be necessary to restart the synchronization process of the method 800.

After the FAC is decoded in one of blocks 908, 910, and 912, the method 900 moves onto one of the corresponding blocks 916, 918, and 920 at which the radio receiver 200 begins full playback of the RF signal. The playback of the RF signal can include reusing data from the FAC. From block 916 (e.g., in the path from which fast detection 1 was the first to complete), the method 900 may also include the radio receiver 200 demodulating and decoding the SDC and correcting the IFO. Block 922 may be performed since the fast detection 1 branch corrects the FFO portion of the received signal and may not have the full CFO correction in the first few symbols. The radio receiver 200 can also take the IFO corrected data and multiply the buffered data by a complex exponential to resolve the remaining IFO and therefore correct and residual CFO. This then allows the radio receiver 200 to fully process the SDC information and achieve the fastest possible TTA. Without doing the IFO compensation step, the radio receiver 200 may not be able to properly demodulate and thus decode the SDC content the first time. The next SDC packet may not arrive until 1.20 seconds later, which would partially lose some of the TTA gain previously achieved by the playback mechanism alone.

Each of the blocks 922, 918, and 920 moves to block 924 at which the radio receiver 200 demodulates and decodes the SDC. Thereafter, at block 926 the radio receiver 200 demodulates and decodes the MSC.

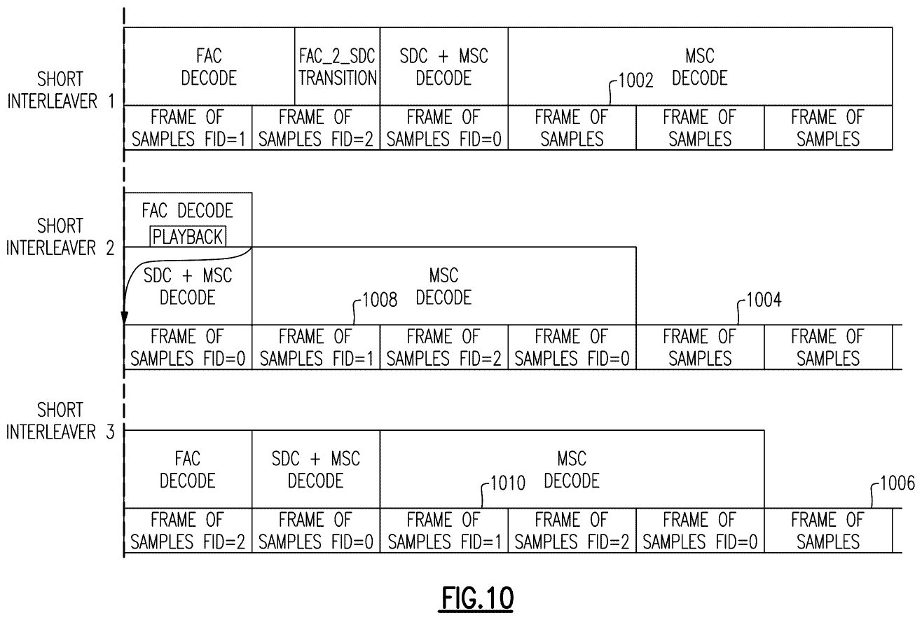

FIG. 10 is a schematic diagram illustrating the TTA for decoding an RF signal for three different cases in accordance with aspects of this disclosure. In particular, a first case is labeled Short Interleaver 1, a second case is labeled Short Interleaver 2, and a third case is labeled Short Interleaver 3. In the first case (Short Interleaver 1), the first frame of samples received by the radio receiver 200 is the frame of samples with a frame ID (FID) of 1. In the second case (Short Interleaver 2), the first frame of samples received by the radio receiver 200 is the frame of samples with an FID of 0. In the third case (Short Interleaver 3), the first frame of samples received by the radio receiver 200 is the frame of samples with an FID of 2.

Because the radio receiver 200 is able to begin full playback (e.g., at blocks 916, 918, and 920 of FIG. 9) once the FAC is decoded, the radio receiver 200 is able to more quickly begin playback by reusing already buffered up CFO/SFO corrected data to achieve a faster TTA. The amount by which the TTA is decreased compared to traditional decoding techniques may depend on which of the three OFDM frames the synchronize process aligns (e.g., the first to third cases Short Interleaver 1-3). For the first to third cases, TTA can be achieved at frames 1002, 1004, and 1006 using a traditional decoding techniques. In the traditional decoding techniques, the old data prior to frames 1002, 1004, and 1006 is discarded without being played back. In contrast, by synchronizing and decoding the signal using the techniques disclosed herein, the TTA can be reduced for the second and third cases to begin at frames 1008 and 1010. In some cases, by using the synchronization and decoding techniques described herein, the best and worst case TTA can be reduced by two OFDM frames (about 800 msec) compared to a traditional synchronization and decoding approach.

In some embodiments, the radio receiver 200 can be configured to buffer the received data without correcting the CFO/SFO. In these embodiments, the radio receiver 200 may not need to perform IFO correction since the CFO and SFO can be corrected on a symbol basis, thus simplifying the playback mechanism.

### Further Example Synchronization and Demodulation Method

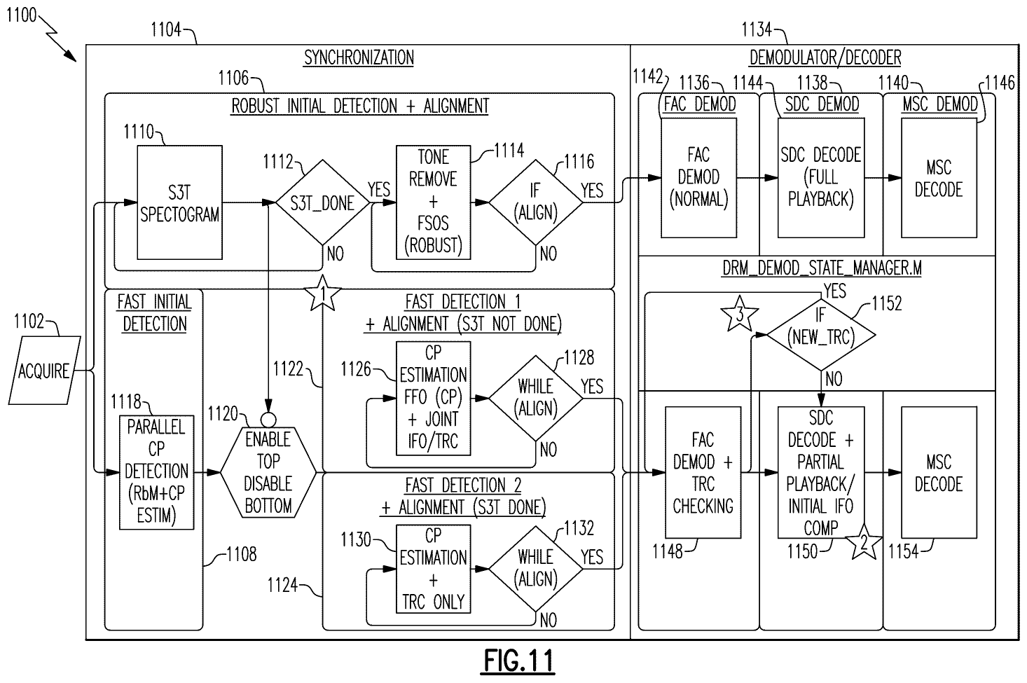

FIG. 11 illustrates an example flowchart for a method of synchronizing a radio receiver 200 to a received RF signal and demodulating/decoding the RF signal in accordance with aspects of this disclosure.

The method 1100 begins at block 1102 where the radio receiver 200 acquires an RF signal. Once the RF signal has been acquired, the radio receiver 200 begins parallel synchronization 1104 with the RF signal. The parallel synchronization 1104 involves running both a robust initial detection and alignment algorithm 1106 and a fast initial detection algorithm 1108 in parallel.

The robust initial detection and alignment algorithm 1106 includes the radio receiver 200 running an S3T algorithm 1110. The radio receiver 200 determines whether the S3T algorithm 1110 has completed in block 1112. If the S3T algorithm 1110 has not yet completed, the radio receiver 200 returns to block to algorithm 1110 and continues running the S3T algorithm 1110. If the S3T algorithm 1110 has completed, the radio receiver 200 performs tone removal and a robust synchronization algorithm in block 1114 such as FSOF. At block 1116, the radio receiver 200 determines whether synchronization with the RF signal has been achieved. If the RF signal is not yet synchronized, the radio receiver 200 continues performing tone removal and the robust synchronization algorithm in block 1114. If the RF signal is synchronized, the robust initial detection and alignment algorithm 1106 completes.

The fast initial detection algorithm 1108 includes performing a fast synchronization algorithm such as parallel CP in block 1118. At block 1120, the radio receiver 200 determines whether to perform the fast detection 1 algorithm 1122 or the fast detection 2 algorithm 1124. In some embodiments, the radio receiver 200 can perform the fast detection 1 algorithm 1122 when the S3T algorithm 1110 has not yet completed, and perform the fast detection 2 algorithm 1124 when S3T algorithm 1110 has completed.

In performing the fast detection 1 algorithm 1122, the radio receiver 200 performs CP estimation, estimating the FFO via CP correlation, and joint estimating the TRC and the IFO at block 1126. At block 1128, the radio receiver 200 determines whether synchronization with the RF signal has been achieved. If the RF signal is not yet synchronized, the radio receiver 200 continues performing CP estimation, estimating the FFO via CP correlation, and joint estimating the TRC and the IFO in block 1126. If the RF signal is synchronized, the fast detection 1 algorithm 1122 completes.

In performing the fast detection 2 algorithm 1130, the radio receiver 200 performs CP estimation and estimating the TRC at block 1130. At block 1132, the radio receiver 200 determines whether synchronization with the RF signal has been achieved. If the RF signal is not yet synchronized, the radio receiver 200 continues CP estimation and estimating the TRC in block 1130. If the RF signal is synchronized, the fast detection 2 algorithm 1124 completes.

Once the radio receiver 200 has synchronized the RF signal, the radio receiver 200 can perform demodulation/decoding of the RF signal in block 1134. The demodulation/decoding in block 1134 includes performing FAC demodulation 1136, SDC demodulation 1138, and MSC demodulation 1140.

In the case that the robust initial detection and alignment algorithm 1106 completes first, the FAC demodulation 1136 includes performing FAC demodulation 1142. In some embodiments, the FAC demodulation 1142 may include any suitable FAC demodulation technique. After the FAC demodulation 1136, the SDC demodulation 1138 can include decoding the SDC and beginning full playback at block 1144. Next, the radio receiver 200 can perform the MSC demodulation 1140 including decoding the MSC at block 1146.

In the case that either the fast detection 1 algorithm 1122 or the fast detection 2 algorithm 1130 completes first, the FAC demodulation 1136 includes performing FAC demodulation and TRC checking at block 1148. The radio receiver 200 then decodes the SDC and begins partial playback and initial IFO compensation in block 1150. In parallel with block 1150, the radio receiver 200 determines whether a new TRC has been received. If there is no new TRC, the radio receiver 200 continues with decoding the SDC and beginning partial playback and initial IFO compensation in block 1150. If a new TRC has been received, the radio receiver 200 returns to block 1148 including performing FAC demodulation and TRC checking. After block 1150, the radio receiver 200 can decode the MSC at block 1154.

While the present invention has been described with respect to a limited number of embodiments, those skilled in the art will appreciate numerous modifications and variations therefrom. It is intended that the appended claims cover all such modifications and variations as fall within the true spirit and scope of this present invention.

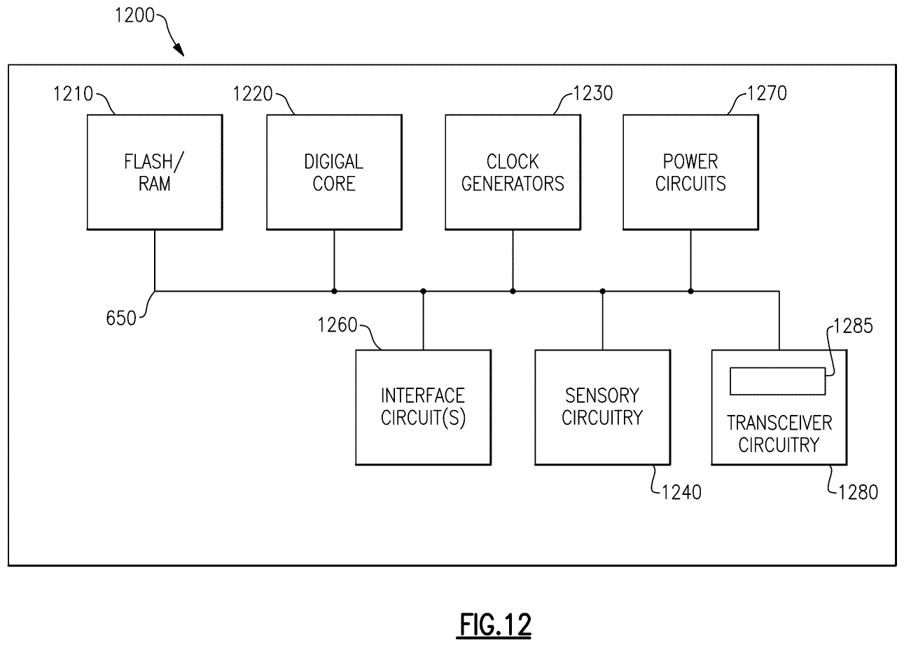

Embodiments may be implemented in many different types of end node devices. Referring now to FIG. 12, shown is a block diagram of a representative device 1200 which may be a given wireless device. In the embodiment shown in FIGS. 5 and 6 device 1200 may be a standalone radio, or a radio incorporated into another device such as a sensor, actuator, controller or other device that can be used in a variety of use cases in a wireless control network, including sensing, metering, monitoring, embedded applications, communications applications and so forth.

In the embodiment shown, device 1200 includes a memory system 1210 which in an embodiment may include a non-volatile memory such as a flash memory and volatile storage, such as RAM. In an embodiment, this non-volatile memory may be implemented as a non-transitory storage medium that can store instructions and data, including code for performing methods including the methods of the flowcharts of FIGS. 8 or 9 or the techniques performed by the systems of FIGS. 5 or 6.

Memory system 1210 couples via a bus 1250 to a digital core 1220, which may include one or more cores and/or microcontrollers that act as a main processing unit of the device. As further shown, digital core 1220 may couple to clock generators 1230 which may provide one or more phase locked loops or other clock generation circuitry to generate various clocks for use by circuitry of the device.

As further illustrated, device 1200 further includes power circuitry 1270, which may include one or more voltage regulators. Additional circuitry may optionally be present depending on particular implementation to provide various functionality and interaction with external devices. Such circuitry may include interface circuitry 1260 which may provide interface with various off-chip devices, sensor circuitry 1240 which may include various on-chip sensors including digital and analog sensors to sense desired signals, such as speech inputs, image inputs, environmental inputs or so forth.

Transceiver circuitry 1280 may be provided to enable transmission and receipt of wireless signals, e.g., according to one or more digital radio communication standards such as DAB, DRM or HD™ radio, local area wireless communication schemes, such as a given IEEE 802.11 scheme, wide area wireless communication scheme such as LTE or 5G, among others. And as shown transceiver circuitry 1280 includes a timing control circuit 1285, which may perform timing estimates as described herein. While shown with this high-level view, many variations and alternatives are possible.

### CONCLUSION

The joint synchronization systems and method described herein can be applied to various different RF standards including the DRM30 radio standard. The disclosed techniques allows the radio architecture to deliver robust detection in low SNR conditions while also providing fast TTA on average in clean signal conditions. The described topology allows the average TTA in clean conditions to decrease by about 50% compared to the previous implementations solution while maintaining substantially the same level of robustness.

Any of the embodiments described above can be implemented in association with mobile devices such as cellular handsets. The principles and advantages of the embodiments can be used for any systems or apparatus, such as any uplink wireless communication device, that could benefit from any of the embodiments described herein. The teachings herein are applicable to a variety of systems. Although this disclosure includes example embodiments, the teachings described herein can be applied to a variety of structures. Any of the principles and advantages discussed herein can be implemented in association with RF circuits configured to process signals having a frequency in a range from about 30 kHz to 300 GHz, such as in a frequency range from about 400 MHz to 8.5 GHz or in a frequency range from about 400 MHz to 5 GHz.

Aspects of this disclosure can be implemented in various electronic devices. Examples of the electronic devices can include, but are not limited to, consumer electronic products, parts of the consumer electronic products such as packaged radio frequency modules, uplink wireless communication devices, wireless communication infrastructure, electronic test equipment, etc. Examples of the electronic devices can include, but are not limited to, a mobile phone such as a smart phone, a wearable computing device such as a smart watch or an car piece, a telephone, a television, a computer monitor, a computer, a modem, a hand-held computer, a laptop computer, a tablet computer, a microwave, a refrigerator, a vehicular electronics system such as an automotive electronics system, a robot such as an industrial robot, an Internet of things device, a stereo system, a digital music player, a radio, a camera such as a digital camera, a portable memory chip, a home appliance such as a washer or a dryer, a peripheral device, a wrist watch, a clock, etc. Further, the electronic devices can include unfinished products.

Conditional language used herein, such as, among others, “can,” “could,” “might,” “may,” “e.g.,” “for example”, “such as” and the like, unless specifically stated otherwise, or otherwise understood within the context as used, is generally intended to convey that certain embodiments include, while other embodiments do not include, certain features, elements and/or states. The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively.

The examples shown in the figures illustrate the filter components or filtering stages as discrete “blocks”. Those skilled in the art will appreciate, given the benefit of this disclosure, that any or all of the filters shown in the various examples may be made up of many stages and/or combined or share components in different physical implementations. Accordingly, the examples shown are intended to be functional illustrations and not limiting in any aspect with respect to actual implementations of the radio frequency circuit assembly or front-end module. Aspects and embodiments provide a noise cancellation approach that can be designed into the overall front-end module configuration such that the overall filter out-of-band attenuations required can be relaxed, requirements on some or all the filter sections may be relaxed to provide more optimal and lower insertion losses, and the net insertion loss and out-of-band attenuation/isolation properties of the entire front-end module may exhibit less loss, more isolation, and more out-of-band attenuation where desired.

While certain embodiments have been described, these embodiments have been presented by way of example only, and are not intended to limit the scope of the disclosure. Indeed, the novel resonators, filters, modules, devices, wireless communication devices, apparatus, and systems described herein may be embodied in a variety of other forms. Furthermore, various omissions, substitutions and changes in the form of the resonators, filters, modules, devices, wireless communication devices, apparatus, and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and/or acts of the various embodiments described above can be combined to provide further embodiments. Accordingly, the foregoing description and drawings are by way of example only, and the scope of the disclosure should be determined from proper construction of the appended claims, and their equivalents.

What is claimed is:

1. A radio receiver comprising:
digital signal processing circuitry configured to receive a radio frequency signal from an antenna, perform a first synchronization algorithm and a second synchronization algorithm on the radio frequency signal in parallel, determine which of the first synchronization algorithm and the second synchronization algorithm completes first, and begin playback on the radio frequency signal based on synchronization with the radio frequency signal based on the determination of which of the first synchronization algorithm and the second synchronization algorithm completed first.

2. The radio receiver of claim 1 wherein the first synchronization algorithm is processed on a longer duration than the second synchronization algorithm.

3. The radio receiver of claim 1 wherein the second synchronization algorithm is processed on a duration of about a single symbol and the first synchronization algorithm is processed on a duration based on about a length of a frame.

4. The radio receiver of claim 1 wherein the second synchronization algorithm is processed on a duration of about a single symbol and the first synchronization algorithm is processed on a duration based on about a length of a super frame.

5. The radio receiver of claim 1 wherein the second synchronization algorithm is processed on a duration of about a length of a frame and the first synchronization algorithm is processed on a duration based on about a length of a super frame.

6. The radio receiver of claim 1 wherein the first synchronization algorithm includes:
determining whether pilots are present in the radio frequency signal, and
in response to determining that pilots are present in the radio frequency signal, determining if there is an interfering tone present in the radio frequency signal.

7. The radio receiver of claim 6 wherein the digital signal processing circuitry is further configured to:
disable second synchronization algorithm in response to determining that the interfering tone is present in the radio frequency signal.

8. The radio receiver of claim 6 wherein the digital signal processing circuitry is further configured to, in response to determining that no interfering tone is present in the radio frequency signal:
determine a robustness mode of the radio frequency signal,
find one or more symbol boundaries of the radio frequency signal,
determine whether a time reference cell is present in a current frame of symbols of the radio frequency signal, and
find a symbol start location of the radio frequency signal.

9. The radio receiver of claim 8 wherein the digital signal processing circuitry is further configured to, in response to determining the robustness mode and finding the symbol start location of the radio frequency signal:
estimate and removing a fractional frequency offset a boundary of a current symbol, and
find whether a time reference cell is present in the current symbol.

10. The radio receiver of claim 1 wherein the second synchronization algorithm includes finding a robustness mode of the radio frequency signal and a symbol start location on a symbol basis.

11. The radio receiver of claim 10 wherein the second synchronization algorithm further includes, in response to finding the robustness mode of the radio frequency signal:
continuing to find the symbol start location on the symbol basis,
estimating and removing a fractional frequency offset on a boundary of a current symbol, and
estimating a time reference cell and an integral frequency offset on the current symbol.

12. The radio receiver of claim 6 wherein the digital signal processing circuitry is further configured to:
maintain a current state of each of the first synchronization algorithm and the second synchronization algorithm in a state machine, and
update the current state of each of the first synchronization algorithm and the second synchronization algorithm based on the determination of which of the first synchronization algorithm and the second synchronization algorithm completes first.

13. A radio receiver comprising:
digital signal processing circuitry configured to receive an indication of which of a first synchronization algorithm and a second synchronization algorithm completed synchronization with a radio frequency signal first, demodulate and decode fast access channel data from the radio frequency signal, and begin playback of the radio frequency signal reusing the fast access channel data and based on the indication of which of the first synchronization algorithm and the second synchronization algorithm completed synchronization with the radio frequency signal first.

14. The radio receiver of claim 13 wherein the first synchronization algorithm is processed on a longer duration than the second synchronization algorithm.

15. The radio receiver of claim 13 wherein the second synchronization algorithm is processed on a duration of about a single symbol and the first synchronization algorithm is processed on a duration based on about a length of a frame.

16. The radio receiver of claim 13 wherein the digital signal processing circuitry is further configured to, in response to the received indication indicating that the second synchronization algorithm completed synchronization with the radio frequency signal first:
determine whether to obtain a new time reference cell; and
in response to determining to obtain the new time reference cell, perform demodulating and decoding of the fast access channel data from the radio frequency signal again.

17. The radio receiver of claim 13 wherein the digital signal processing circuitry is further configured to:
performing one or more cyclic redundancy checks on the fast access channel data, and
in response to determining that the fast access channel data has failed a predetermined number of cyclic redundancy checks, reinitialize the radio receiver and performing the first synchronization algorithm and the second synchronization algorithm on the radio frequency signal in parallel.

18. The radio receiver of claim 13 wherein the digital signal processing circuitry is further configured to, in response to received indication indicating that the second synchronization algorithm completed synchronization with the radio frequency signal first without demodulating and decoding an integral frequency offset of the radio frequency signal:
demodulate and decode an integral frequency offset of the radio frequency signal after beginning playback of the radio frequency signal.

19. A wireless communication device comprising:
an antenna; and
transceiver circuitry in communication with the antenna and configured to receive a radio frequency signal from the antenna, perform a first synchronization algorithm and a second synchronization algorithm on the radio frequency signal in parallel, determine which of the first synchronization algorithm and the second synchronization algorithm completes first, and begin playback on the radio frequency signal based on synchronization with the radio frequency signal based on the determination of which of the first synchronization algorithm and the second synchronization algorithm completed first.

20. The wireless communication device of claim 19 wherein the first synchronization algorithm is processed on a longer duration than the second synchronization algorithm.
